(19) United States
(12) Patent Application Publication
(10) Pub. No.: US 2003/0063312 A1
(43) Pub. Date: Apr. 3, 2003

(54) Image processing method and image processing system

(76) Inventors: Tetsuya Kurimoto, Tokyo (JP); Nobutoshi Shoji, Miyagi (JP); Shinichi Shoji, Miyagi (JP)

Correspondence Address: CANTOR COLBURN, LLP, 55 GRIFFIN ROAD SOUTH, BLOOMFIELD, CT, 06002

(21) Appl. No.: 10/154,583

(22) Filed: May 24, 2002

(30) Foreign Application Priority Data
Jun. 1, 2001 (JP) 2001-167320
Jun. 1, 2001 (JP) 2001-167321

(51) Int. Cl. B41J 1/00; G06F 15/00

(52) U.S. Cl. 358/1.15

(57) ABSTRACT

An image processing method utilizing a system including a terminal having an operating section, a server having a storing section and a digital image processing apparatus connected each other via a network, comprising the steps of: providing a folder having an initial name and having a plurality of image files therein into the storing section in the server by the operating section of the terminal; obtaining the image files form the folder via the network and processing the obtained image file to obtain a print with the digital image processing apparatus; and changing the initial name of the folder in accordance with the progressive condition of the obtaining step and the processing step.

### FIELD OF THE INVENTION

The present invention relates to an image processing method, and in particular, to a digital image processing method wherein file management can be exercised easily. In recent years, the so-called minilab systems have been spreading as a system for making photographic prints simply. Recent features in these minilab systems include problems that a cost competition is fierce because of increased minilabs, processing for APS films is complicated, and processing for digital cameras takes a long time. Under the intense circumstances surrounding the minilabs, photographic service with high value added has come to be required.

### BACKGROUND OF THE INVENTION

In conventional photographic print service in minilabs, a customer brings a film to the minilab, and when that film is an undeveloped film, the film is developed to be a developed film, while, when the film is a developed film, the film is scanned by a film scanner for printing, and finished prints are offered to the customer.

In the conventional photographic print service mentioned above, when an image file is transferred from a digital image processing apparatus side to a personal computer side under the condition that the digital image processing apparatus is connected with the personal computer, transferring has been conducted for each file, which has caused complexity and difficult management, when a large number of images are transferred. Even in the case of printing of images, printing has been conducted in a unit of image file, which, therefore, has caused a problem of complicated processing.

Further, since the image file conducts nothing but transferring image data simply, the state of processing (image processing, printing) cannot be controlled, which is a problem.

### SUMMARY OF THE INVENTION

The invention has been achieved in view of the problem stated above, and its objects are to provide an image processing method wherein an image file can be controlled easily for attaining efficient processing, and the state of processing can be controlled.

Above objects can be achieved by following Items.

Item.1

An image processing method utilizing a system including a terminal having an operating section, a server having a storing section and a digital image processing apparatus connected each other via a network, comprising the steps of:

providing a folder having an initial name and having a plurality of image files therein into the storing section in the server by the operating section of the terminal;

obtaining the image files from the folder via the network and processing the obtained image file to obtain a print with the digital image processing apparatus; and

changing the initial name of the folder in accordance with the progressive condition of the obtaining step and the processing step.

Item.2

The image processing method of Item.1, wherein the server is provided in the terminal.

Item.3

The image processing method of Item.1, wherein the network is a local area network.

Item.4

The image processing method of Item.1, wherein the initial name comprises an extension and the extension is changed when the initial name of the folder is changed.

Item.5

The image processing method of Item.4, wherein the initial name of the folder is changed to a second name when the obtaining step is finished.

Item.6

The image processing method of Item.5, wherein the second name is changed to a third name when the processing step is finished.

Item.7

The image processing method of Item.5, wherein the second name comprises an extension, which represents that the processing step is in progress.

Item.8

The image processing method of Item.6, wherein the third name comprises an extension, which represents that the processing step is finished.

Item.9

The image processing method of Item.4, wherein when an error is occurred during the obtaining step or the processing step, the extension is changed to an extension, which represents that an error is occurred.

Item.10

The image processing method of Item.5, wherein when the processing step is abandoned, the second name is changed to a name, which represents the abandon.

Item.11

The image processing method of Item.1, wherein the initial name comprises an order number, which represents ordering of priority, and the obtained image file is processed by the digital image processing apparatus in order of the order number.

Item.12

An image processing method utilizing a system including a terminal having an operating section, a server having a storing section and a digital image processing apparatus connected each other via a network, comprising the steps of:

providing a folder capable of storing a plurality of image files therein and having an initial name by the operating section of the terminal;

making an image file by scanning a photographic film or by reading a media having an image data with the digital image processing apparatus;

transferring the image file from the digital image processing apparatus into the folder; and

changing the initial name of the folder in accordance with a progressive condition of the making step and the transferring step.

Item.13

The image processing method of Item.12, wherein the server is provided in the terminal.

Item.14

The image processing method of Item.12, wherein the network is a local area network.

Item.15

The image processing method of Item.12, wherein the initial name comprises an extension and the extension is changed when the initial name of the folder is changed.

Item.16

The image processing method of Item.15, wherein the initial name of the folder is changed to a second name when the making step is finished.

Item.17

The image processing method of Item.16, wherein the second name is changed to a third name when the transferring step is finished.

Item.18

The image processing method of Item.12, wherein the image file is transferred from the digital image processing apparatus into the folder, when the initial name is a predetermined name.

Item.19

The image processing method of Item.12, wherein digital image processing apparatus makes the image file by scanning the photographic film and the image file comprises at least a serial number of the personal computer, number of roll films and the order of exposures of the photographic film.

Item.20

The image processing method of Item.12, wherein the initial name comprises an order number, which represents ordering of priority, and the obtained image file is transferred from the digital image processing apparatus into the folder in order of the order number.

Item.21

An image processing method utilizing a system including a terminal having an operating section, a server having a storing section and a digital image processing apparatus connected each other via a network, comprising the steps of:

providing a folder capable of storing a plurality of image files therein and having an initial name by the operating section of the terminal;

making an image file by scanning a photographic film or by reading a media having an image data with the digital image processing apparatus; and

transferring the image file from the digital image processing apparatus into the folder, when the initial name of the folder is a predetermined name.

Item.22

The image processing method of Item.21, wherein the server is provided in the personal computer.

Item.23

The image processing method of Item.21, wherein the network is a local area network.

Item.24

An image processing system comprising:

a server having a storing section;

a digital image processing apparatus connected with the server each other via a network;

a providing section for providing a folder into the storing section, and the folder being capable of storing a plurality of image files and having an initial name;

a transferring section for transferring the image file between the storing section and the digital image processing apparatus; and

a changing section for changing the initial name of the folder in accordance with a progressive condition of transferring.

Item.25

An image processing system comprising:

a server having a storing section;

a providing section for providing a folder into the storing section, and the folder being capable of storing a plurality of image files and having an initial name;

a transferring section for transferring the image file between the storing section and the digital image processing apparatus;

a digital image processing apparatus being capable of processing the image file to obtain a print and connected with at least the server each other via a network; and

a changing section for changing the initial name of the folder in accordance with a progressive condition of processing.

### BRIEF DESCRIPTION OF DRAWINGS

FIG. 1

A block diagram showing an embodiment of the invention.

FIG. 2

A diagram showing an inside of the folder.

FIG. 3

A part of a flow chart showing an example of system operation relating to the present invention.

FIG. 4

A part of a flow chart showing an example of system operation relating to the present invention.

FIG. 5

A part of a flow chart showing an example of system operation relating to the present invention.

FIG. 6

A part of a flow chart showing an example of system operation relating to the present invention.

FIG. 7

A part of a flow chart showing an example of system operation relating to the present invention.

FIG. 8

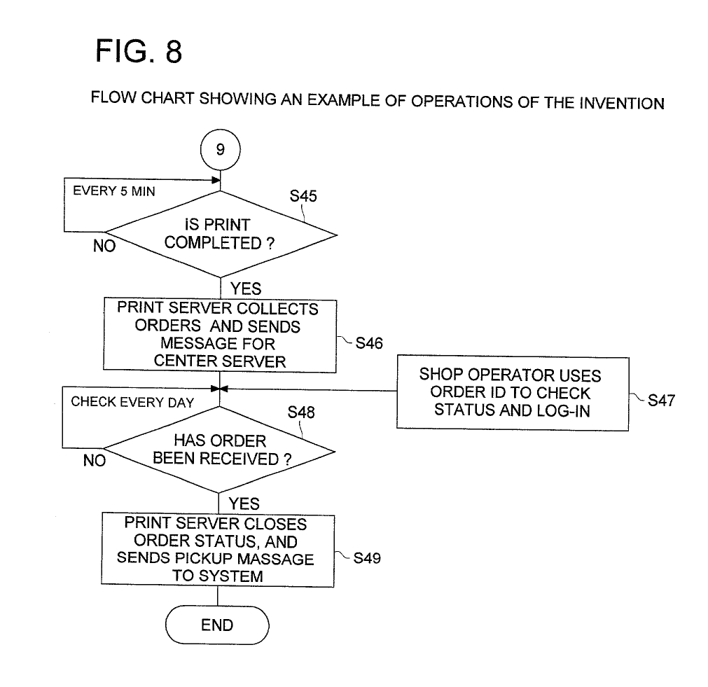

A part of a flow chart showing an example of system operation relating to the present invention.

FIG. 9

A part of a flow chart showing an other example of system operation relating to the present invention.

FIG. 10

A part of a flow chart showing an other example of system operation relating to the present invention.

### PREFERRED EMBODIMENTS OF THE INVENTION

Embodiments of the invention will be explained in detail as follows, referring to the drawings. In the embodiment, there is shown an occasion wherein the invention is applied to the processing of photographic images, as a typical example of the invention.

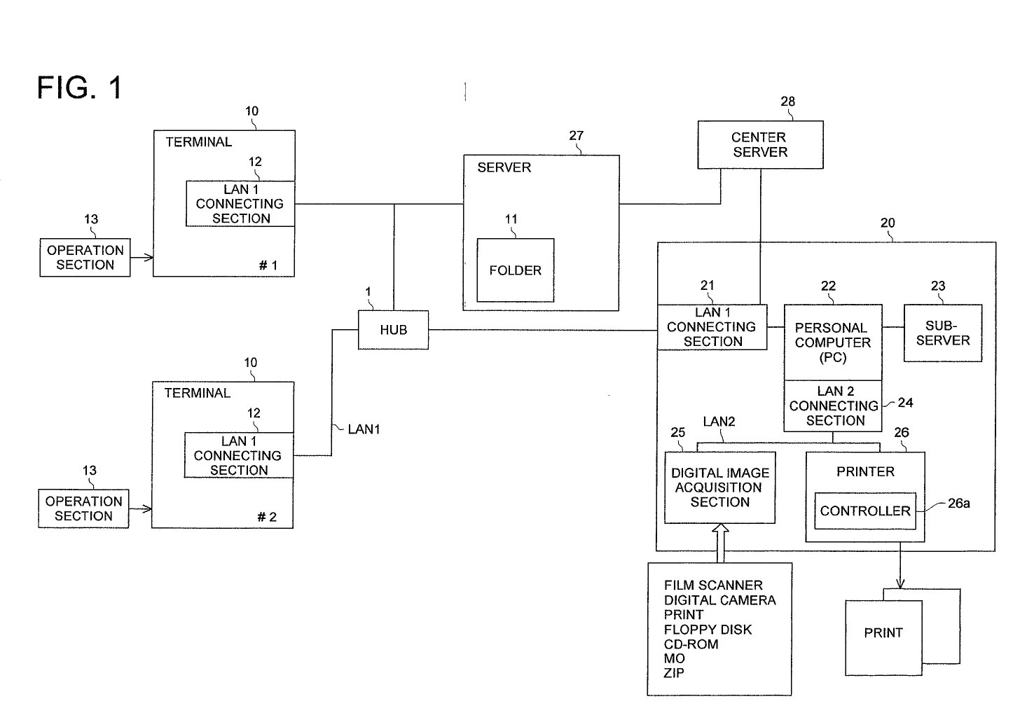

FIG. 1 is a block diagram showing an embodiment of the invention. In the diagram, the numeral 10 represents a terminal. This terminal may either be a terminal installed inside a shop where a minilab system is installed, a personal computer owned by a customer, or a terminal installed in a convenience store. Further, a plurality of terminals 10 may be connected as shown in #1 and #2 in the drawing, or even more terminals may be connected. The numeral 12 is a connection section to LAN1 (local area network) for connecting to another terminal, a server and digital image processing apparatus 20, to which, however, the invention is not limited, and a network utilizing a telephone line can also be used. LAN1 is arranged to be connected also to other equipment through hub 1. Though the present embodiment shows an occasion where a digital photographic processing apparatus is used as a digital image processing apparatus, the invention is not limited to this.

The numeral 27 represents a server having therein a storage section, and folder 11 for storing therein an image file is provided in the server. The server 27 may also be provided in a hard disk of terminal 10, and in that case, folder 11 is also provided on a storage section in the terminal 10.

The numeral 13 represents an operation section which is connected to the terminal 10 and is used for inputting various types of information. As the operation section 13, a key board or a mouse, for example, is used. In digital photographic image processing apparatus 20, the numeral 21 is a connection section to LAN1, and it is connected to a server through the network and is connected to terminal 10 through hub 1. Let it be assumed that LAN constructed in this manner is represented by LAN1. The numeral 22 represents a personal computer (PC) included in a digital photographic processing apparatus connected to LAN1, 23 represents a sub-server which is connected to personal computer 22 and is used for storing various types of information, and sub-server 23 may also be provided on a hard disk of the personal computer 22. In the personal computer 22, there is included a transfer means that transfers an image file from the digital photographic image processing apparatus 20 side to server 27 or to terminal 10 side.

The numeral 24 represents a connection section to the second LAN (LAN2) provided on personal computer 22, while, the numeral 25 represents a digital image acquisition section connected with LAN 2. To the digital image acquisition section 25, there is connected a film scanner, a digital camera, a floppy disk (FD), CD-ROM or a reading apparatus of ZIP, or there is inputted a print. The digital image acquisition section 25 is one that is connected with the aforesaid equipment to acquire image information as a digital image. The numeral 26 represents a printer for printing a photograph, and 26a represents a controller that controls the printer. The personal computer 22, the digital image acquisition section 25 and the printer 26 are connected each other through LAN 2 representing the second LAN. The personal computer 22 and server 27 may also be connected with a server having a storage section that is called a center server and has a large capacity through a network, as shown with dotted lines. The invention will be explained as follows, referring to the system structured in the aforesaid manner.

Digital photographic image processing apparatus 20 can obtain prints by acquiring digital images from the various media described below, because it has digital image acquisition section 25.

1) Development of negative films and various prints from those developed negative films

2) Reorder prints from negative films and reversal films

3) Prints from print documents

4) Prints from digital cameras

5) Prints from image data stored in various media such as FD, MO, CD-ROM and ZIP.

Further, the digital image acquisition section 25 and the personal computer 22 are connected to each other through a network, which makes it possible to give the following services.

(a) Editing print for a album and a greeting card

(b) Media writing service from photographic images to CD-ROM or FD

(c) Functions as network printers

A customer usually brings a film in a shop where digital image processing apparatus 20 is installed. When the film brought in is an undeveloped film, it is developed by an equipment in digital image acquisition section 25, and is scanned by a film scanner in the digital image acquisition section 25 to be converted into digital image data.

Next, a preferable form of a digital image processing method of the invention will be explained.

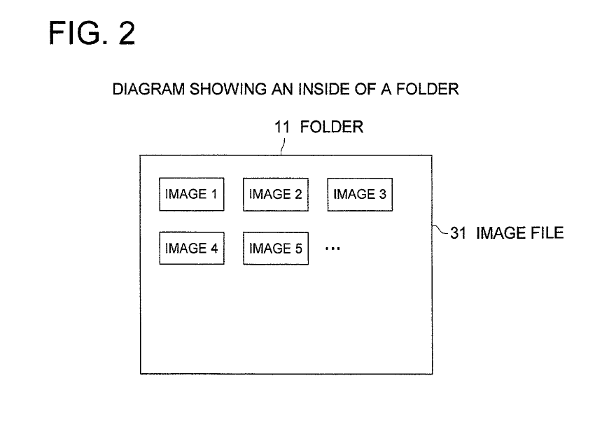

In a preferable form, a customer or a reception operator of the shop prepares folder 11 that stores image file 31 in server 27 by using operation section 13, on the terminal 10 side. It is possible to store a plurality of image files 31 in the folder 11 as shown in FIG. 2. When receiving an image file from the digital photographic image processing apparatus 20 side in this case, an indication of “ORD”, for example, can be used for an extension of the folder. In this case, this extension “ORD” represents an extension in the case of ordering from the terminal 10 side to the digital photographic image processing apparatus 20 side.

On the digital photographic image processing apparatus 20 side, folder 11 of server 27 is referred through LAN1 simultaneously with film scanning. When there is present a folder wherein an indication of “ORD” is used for the extension in this case, personal computer 22 on the digital photographic image processing apparatus 20 side stores an image acquired through reading by a film scanner in sub-server 23, and transfers successively image files to the corresponding folder 11 of the server 27 through LAN1.

Though there has been indicated an occasion wherein a digital image is obtained by scanning a film in the aforesaid form, the invention is not limited to this, and it is possible to obtain input from various types of media stated above as digital images at digital image acquisition section 25.

In this way, image files can be administrated easily.

Personal computer 22 of the digital photographic image processing apparatus 20 can use following forms as a form of an image file to be transferred to the server 27 side.

Qdaaabccc.JPG/BMP/TIFF

In the foregoing, “aaa” shows an order number, “b” shows the number of roll films ordered, and “ccc” shows a sequence of frames in the film roll. Either one of extension JPG, EMP and TIFF (JPG/BMP/TIFF) is used. Each of JPG and TIFF is an extension showing image compression, and MBP shows a non-compression method of a bit-map. This construction makes it possible to form an image file including order information (sequence of order or the like), and thereby, conditions of orders on the terminal 10 side can be recognized.

The digital photographic image processing apparatus 20 can rename the folder in accordance with each result of occasions such as, the occasion when transfer of image files is completed, the occasion when an error is caused in the course of film scanning, or the film scanning cannot be continued, or the occasion when the order is canceled.

For example, when the transfer of an image file is completed, the extension is renamed with an order reception number on the part of the digital photographic image processing apparatus 20, while, when an error is caused in the course of film scanning, or the film scanning cannot be continued, the extension is renamed to “ERR”, and when the order is canceled, the extension is renamed to “000”. Under this construction, it is possible to recognize the status by referring the extension of the folder on the part of terminal 10, and to administrate processing conditions on the part of the digital photographic image processing apparatus 20.

In the aforesaid form, image data can be transferred more easily, because terminal 10 is connected to server 27 through hub 1, and server 27 is connected to digital photographic image processing apparatus 20 through LAN1.

As another form of the invention, a customer or an operator of a shop on the part of the terminal 10 prepares on server 27 the folder 11 including plural files 31 by using operation section 13. In this case, it is possible to give a name of “ORD” as an initial value to the folder. In this case, “ORD” is an extension of the folder name.

As an order, it is possible to assign with a folder name “PCAAA.BBB” or “PCAAAAA.BBB”. “BBB” is an extension, and an initial value is the above-mentioned “ORD”. In the former folder names, “AAA” is an order number which is defined within a range, for example, of 001-999. In this system, it is possible to employ a form wherein orders of 500-999, for example, are made to be the numbers of orders having higher priority and they are processed preferentially.

In the latter folder names, “AAAAA” represents order numbers which are defined within a range, for example, of 01000-30000. It is assumed in this case that no priority is considered in this form. “BBB” is an extension of the folder, and “ORD” becomes an extension in the case of ordering from the terminal 10 side. In this form, therefore, writing of image data in the folder 11 and of necessary files needs to have been completed at the point of time to become an extension of “ORD”.

Personal computer 22 of digital photographic image processing apparatus 20 accesses the folder 11 of server 27, then, reads image file 31 stored in the folder, and makes prints with printer 26. To be concrete, a target folder is found out by referring folder 11 of server 27 by using LAN1. When the digital photographic image processing apparatus 20 is in operation in this case, the extension of the folder is renamed to “PRG” or the like. When operations of the digital photographic image processing apparatus 20 have been completed, the extension is renamed to the order reception number (001-999).

When a problem is caused in the course of printing, the personal computer 22 renames the extension of the folder from “BBB” to “ERR”. When the order is canceled on the part of the digital photographic image processing apparatus 20, the personal computer 22 renames the extension of the folder from “BBB” to “000”.

When renaming, sections other than the extension may also be changed, in addition to the method to rename the extension as stated above. For example, in the case of the folder name of “AAbb.ORD”, it is possible to rename “AAbb” to be “AAcc” without changing “ORD” that represents the extension.

Even when the folder name includes no extension, a change can be made in the same way. For example, when the folder name is simply “AAAb”, a part of the folder name can be changed as shown in “AAAc”, or the whole name of the folder can be changed.

Under the aforesaid form, it is possible to administrate the state of processing process on the part of terminal 10, by confirming how the folder name (extension) is by referring to folder 11 of server 27. After printing for the image file in the folder is completed without accident in this case, the personal computer 22 conducts back printing on the back side of a print by controlling printer 26. As a type of back printing, for example, there are given a reception number of the digital photographic image processing apparatus 20 and an serial number of a customer. Back printing of these numbers makes inspection and verification to be easy.

In the aforesaid form, image data can be transferred more easily, because terminal 10 is connected to server 27 through hub 1, and server 27 is connected to digital photographic image processing apparatus 20 through LAN1.

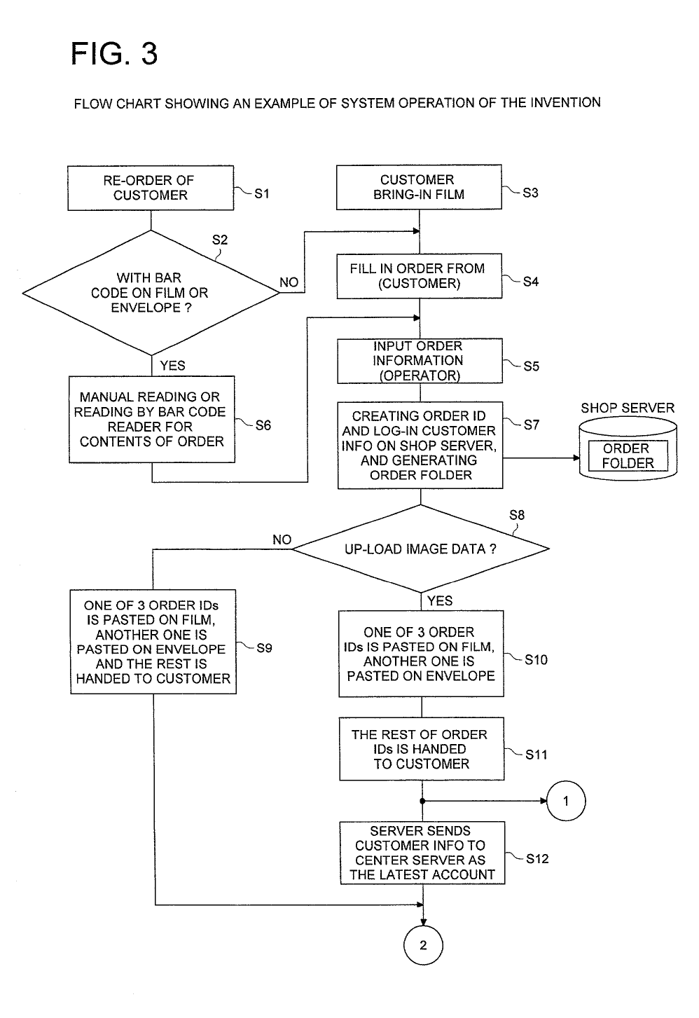

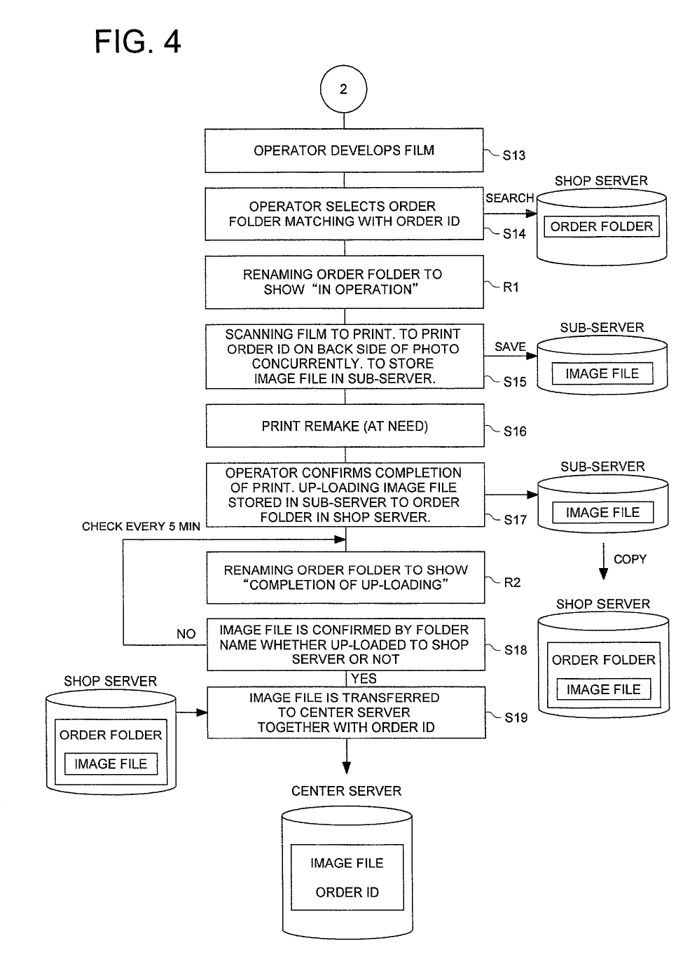

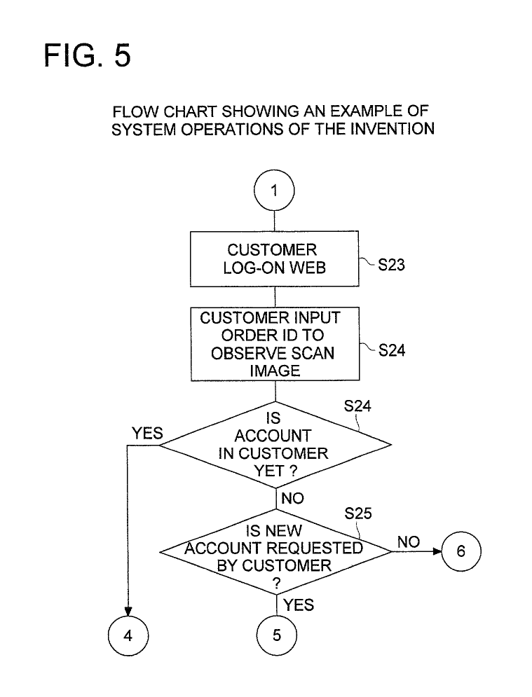

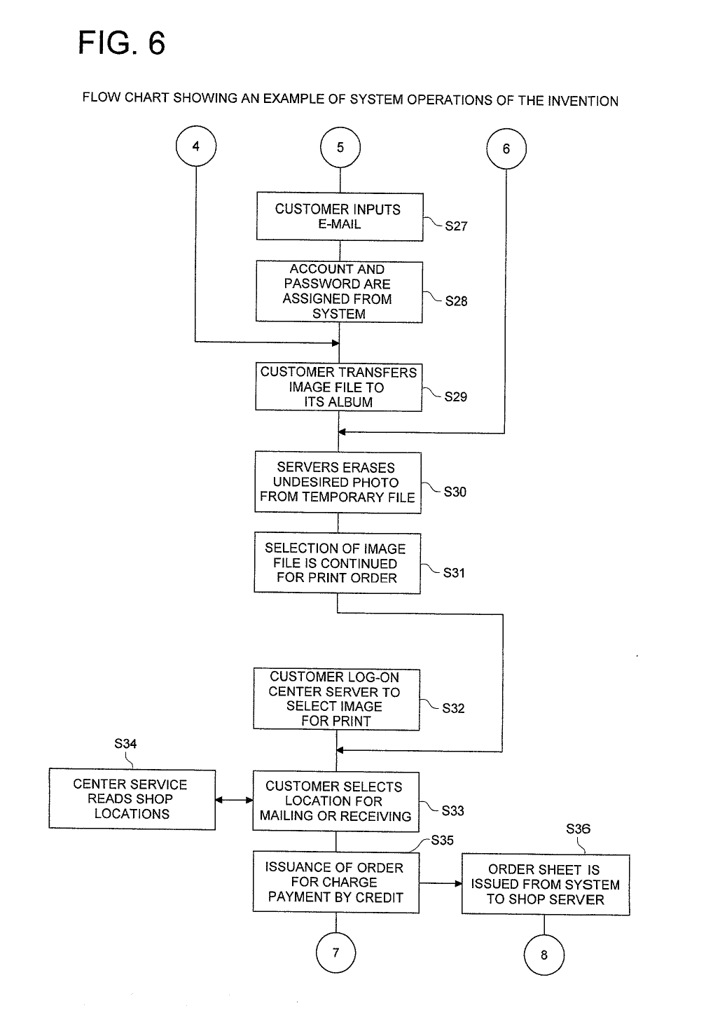

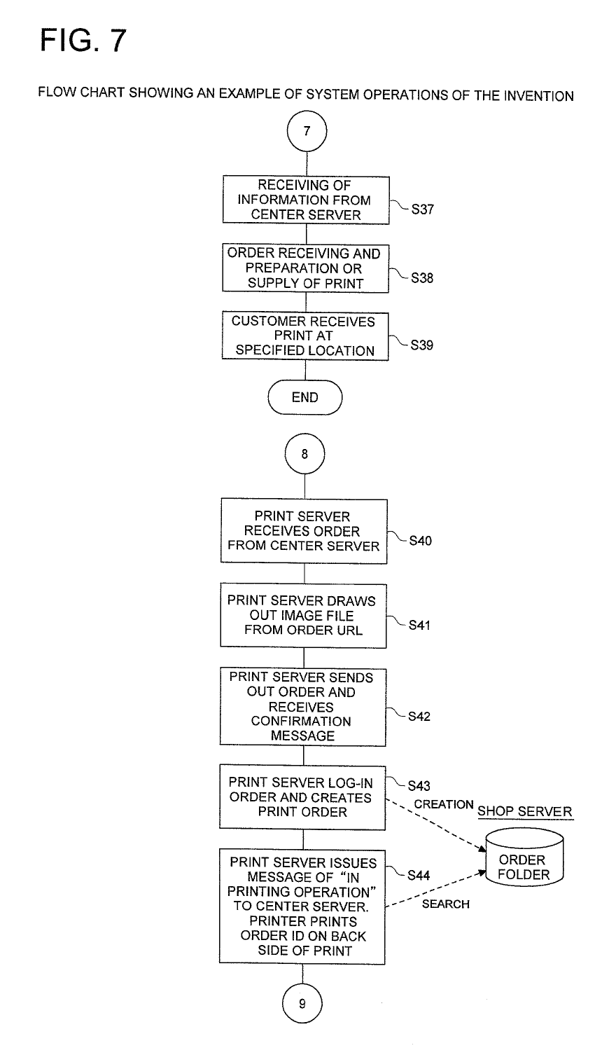

Next, a digital image forming method employing one form of the invention will be explained as follows, referring to the chart. Each of FIG. 3-FIG. 7 is a flow chart showing an example of operations of a digital image forming method employing one form of the invention. Let it be assumed, in this case, that a center having a center server and a shop having therein a digital photographic image processing apparatus 20 are connected to each other through the Internet. In the shop, there are provided a reception equipment (terminal 10) and a shop server (server 27). An occasion where a customer visits a shop and orders a print will be explained as follows.

A customer brings a film in a shop (S3). Then, the customer fills in an order form by writing customer information and contents of an order (S4). In the case of re-order (S1), a bar code is checked whether it is printed on a film or on an envelope for negative film or not (S2). When no bar code is printed, the flow advances to step S4.

When a bar code is printed on a film or on the envelope for negative film in step S2, manual reading of order contents or reading by a bar code reader is conducted, thus, the customer information and contents of previous order can be read.

If the name of a photofinishing laboratory, a date of photofinishing and a photofinishing order number are printed on an edge portion of the envelope for negative film or on the surface of a cartridge, in the case of re-order, records of developing conditions can be taken out of the information to be utilized, when the shop is the same photofinishing laboratory or the trader concerned. In that case, if the information related to the developing is described in the form of a bar code, a magnetic recording or of characters, automatic reading is possible, if the shop has therein a bar code reader, a magnetic information reader or OCR. It is also possible for an operator to input manually by observing the aforesaid recorded information.

A reception operator in a shop inputs order information (S5). The order information in this case includes, for example, a name of a customer, a telephone number, a date, an address, a film type, a print type, quantity of prints and a frame number.

Next, an order ID, log-in information of a customer and order folder (folder 11) are prepared on a shop server (S7). As a name of the order folder, there is established an extension “ORD” as stated above.

Next, the operator investigates whether to conduct printing only for the film brought in or to conduct uploading image data to the center (S8). When no up-loading is needed, three order ID stickers (tags) are printed from terminal 10, and one of them is pasted on the film, the other one is pasted on the envelope for negative film, and the rest is handed over to the customer (S9). After that, the flow advances to step S13.

In the step S8, even when up-loading image data, three order ID stickers (tags) are printed from terminal 10, and one of them is pasted on the film, the other one is pasted on the envelope for negative film (S10), and the rest is handed over to the customer (S11). After that, the customer advances to step 23, and the operator sends customer information to the center server as the latest account (S12). After that, the flow advances to step S13.

Next, the operator who is in charge of digital photographic image processing in the shop develops the film (S13). Then, the operator uses personal computer 22 shown in FIG. 1 to select the folder that matches the order ID (S14). To be concrete, the order folder of the shop server is searched. As a method to search for the folder, there are available two methods; one is an automatic recognition method to read the number with a bar code reader, the other is a manual method to select the folder that matches the film number. On this point, a name of the order folder is renamed to the name indicating “in operation” (extension: PGR) (R1).

Next, the operator conducts film scanning and printing. In this case, the order ID is printed on the back side of the print photograph obtained. Then, the image file is stored in sub-server 23 (S15). The reason for storing the image file in the sub-server is to store the image file temporarily in a provisional storage section to be ready for processing for possible reorder print.

Then, print remake is conducted if necessary (S16). The print remake is conducted in the case of frame slip or when color adjustment is needed. A method of the print remake includes a way to put a film in correctly again and a way to read an image file. Concurrently with the print remake, an image file on the storage section of the sub-server is overwritten. After completion of the print remake, the operator confirms that printing has been done, and uploads the image file stored in the sub-server to an order folder in a shop server (S17). On this point, a name of the order folder is renamed to the name indicating completion of up-loading of the image file (R2).

Next, whether up-loading of the image file for the shop server has been completed or not is investigated (S18). A method of the investigation includes a method of a manual operation to use a button and a method to read a bar code, in both of which, the up-loading of the image file can be confirmed by an extension with a name of the order folder. When the up-loading of the image file has not been completed, it is checked up every 5 minutes. Then, these image files are transferred to the center server by using, for example, the Internet. Or, images are written in CD-ROM or the like.

After the operator handed an order ID sticker to a customer in step S11, the customer conducts log-on to the center server (the numeral 28 in FIG. 1) on the web (S23). The customer inputs the order ID described on the sticker received in step S11 to observe the image file (S24). Then, the customer checks up whether the account (registration number) is already owned or not (S25). When the account is not owned, the customer checks up whether the new account is required or not (S26).

When the new account is required in step S26, the customer contacts the shop or the center through an electronic mail (S27). Then, the shop or the center assigns a new account and a password (S28). The customer transfers an image file on the center server to the album of the customer with the account and the password (S29). The foregoing also applies to the occasion where the account is owned in step S25. Then, the center server eliminates undesired photographs from the image file (S30). The foregoing also applies to the occasion where the new account is not required in step S26. Next, selection of an image file is continued for print ordering (S31). Then, the flow advances to step S33.

The customer selects an image for printing by conducting log-on to the center server (S32). Then, the customer selects the location for mailing or for receiving (S33). At the center service in the center server, locations of shops are inspected (S34). Then, charge payment by credit and issuance of order are conducted (S35). After that, the shop receives order information from the center server (S37). Thus, receiving of the order and preparation or supply of prints are conducted (S38). Then, the customer visits the fixed location (photo-shop or the like) with an order ID to receive the prints (S39).

When the order is placed with the shop server from the system in step S36, a print server of the system receives an order from the center server (S40). Then, the print server draws an image file out of order URL (S41). After that, the print server sends out the order and receives a confirmation message (S42). The print server conducts log-in to the order server to generates a print order (S43).

Next, the print server issues the message indicating “in process of printing” to the center server (S44). Then, printing is checked up whether it has been completed or not (S45). When it is not completed, printing is observed every 5 minutes to be checked whether it has been completed or not. When the printing is completed, the print server collects the order for the center server and sends out the message (S46).

The shop operator uses an order ID for investigating the status and log-in (S47). Then, the order is checked whether it has been accepted or not (S$8). When it has not been accepted, it is checked every day whether it has been accepted or not. When it has been accepted, the print server closes the order status and sends out a pickup message to the system (S49).

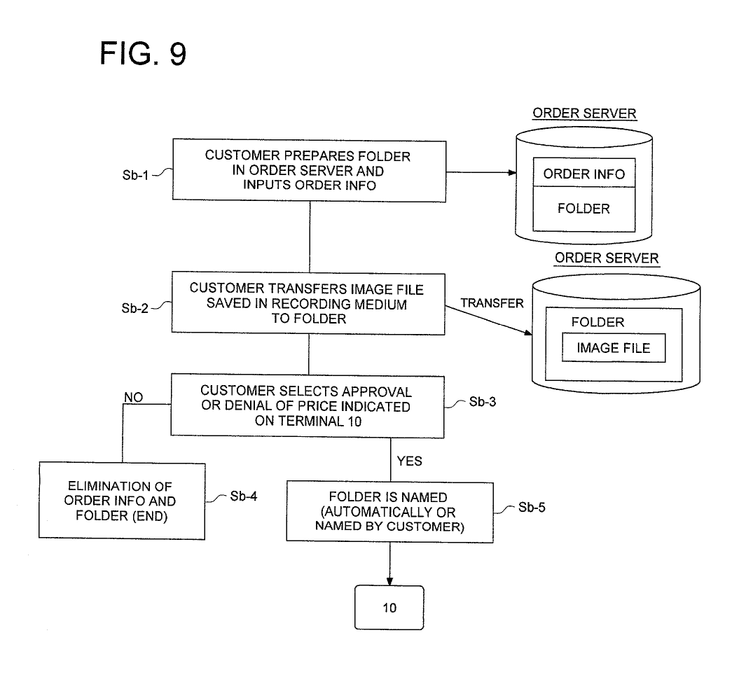

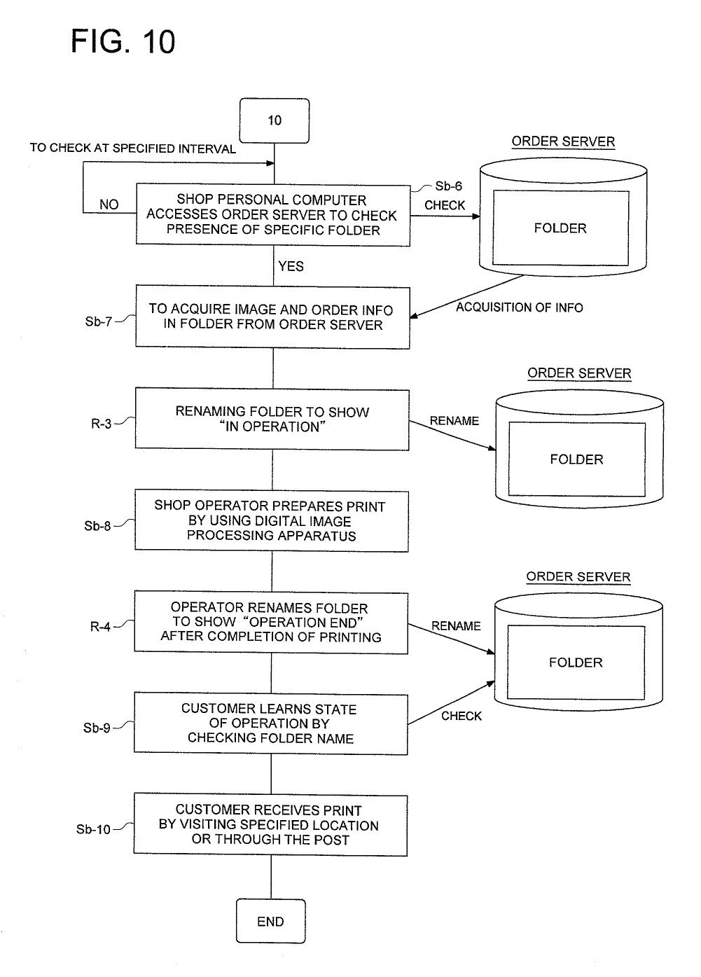

Another example of operations of the invention will be explained next. Each of FIGS. 9 and 10 is a flow chart showing an example of operations of the image processing method of the invention. Let is be assumed, in this case, that a terminal (representing a personal computer owned by the customer or a terminal installed in a convenience store) and an order server are connected through the network (LAN or telephone lines), and the order server is also connected equally to a personal computer in a shop having a digital photographic image processing apparatus. The customer gives an order for prints from a personal computer of the customer or from a terminal installed in a convenience store.

The customer prepares a folder on the order server (corresponding to server 27 in FIG. 1) by using input section 13 installed in a terminal (corresponding to terminal 10 in FIG. 10), and inputs order information (Sb-1). The order information includes a name of a customer, a telephone number, a date, an address, a preservation form for images, a print type, quantity of prints, a frame number and a method of receiving prints.

Next, the customer transfers the image file preserved on a specific recording medium (CD-ROM, FD or the like) to the folder prepared on the order server by using the terminal stated above (Sb-2).

On the terminal 10, there is indicated a price corresponding to the contents of the customer's order, and the customer determines whether it admits the price or not (Sb-3).

When the customer cancels the order, the folder prepared on the order server stated above and the order information are erased (Sb-4).

When the customer admits the price for the order, the folder is given a specific name (Sb-5). As a name of the folder in this case, names such as “PCAAA.BBB” and the like can be used as mentioned above, and “AAA” represents an order number, while, “ORD” representing an extension in the case of placing an order from a terminal side is used for “BBB”. The folder name may either be given by the customer, or it may be given automatically by the order server. Further, with respect to the method for the customer to pay a charge, it is possible to select a method to pay charges by credit or a method to pay by transferring, when the terminal 10 is a personal computer of the customer. When the terminal 10 is an exclusive terminal installed in a convenience store, an apparatus for collecting charges on the spot may also be installed, in addition to the method stated above.

On the other hand, the personal computer in the shop accesses the order server to check whether there is a folder having an extension of “ORD” or not (Sb-6). Checking may either be conducted manually by an operator or it may be conducted automatically by a personal computer at specific intervals.

When the folder having an extension of “ORD” is observed, the shop obtains images and order information in the folder from the order server (Sb-7).

On this point, the folder is renamed to be of the folder name indicating “in process of operation” (R-3) (for example, changing an extension to “PRG”).

Then, the operator makes prints in accordance with the aforesaid order information by using a digital photographic image processing apparatus (Sb-8).

When the printing operations are completed, the folder is renamed to the name indicating “completion of operations” (for example, the extension of the folder is renamed to the number of the order reception number (001-999) of the corresponding folder) (R-4).

When a problem is caused in the course of printing, the extension of the order folder is renamed to “ERR” indicating that a problem is caused (R-4).

When the order is canceled, the extension of the order folder is renamed to “000”.

The customer checks up the extension of the order folder (Sb-9). The customer can learn the status of printing by checking the extension of the order folder.

The customer receives a print at the specific location or through mailing (Sb-10).

Incidentally, as a method to receive a print, when the customer desires to receive at the specific location (shop), the customer visits the specific shop and can receive the print, after checking the completion of the print with the extension of the order folder. Further, as a method to receive a print, it is preferable that an expected date of arrival is indicated in the order folder when the customer desires mailing.

In the embodiment example stated above, an example of the photographic image processing system has been explained as image processing. However, the invention is not limited to this, and the invention can also be applied equally to other types of image processing, such as, for example, image processing for the medical field and the field of graphic arts.

### Effects of the Invention

As stated above, the invention makes administration of image files to be easy, and makes is possible to provide an image processing method in which the process for processing can easily administrated.

What is claimed is:

1. An image processing method utilizing a system including a terminal having an operating section, a server having a storing section and a digital image processing apparatus connected each other via a network, comprising the steps of:
providing a folder having an initial name and having a plurality of image files therein into the storing section in the server by the operating section of the terminal; obtaining the image files from the folder via the network and processing the obtained image file to obtain a print with the digital image processing apparatus; and
changing the initial name of the folder in accordance with the progressive condition of the obtaining step and the processing step.

2. The image processing method of claim 1, wherein the server is provided in the terminal.

3. The image processing method of claim 1, wherein the network is a local area network.

4. The image processing method of claim 1, wherein the initial name comprises an extension and the extension is changed when the initial name of the folder is changed.

5. The image processing method of claim 4, wherein the initial name of the folder is changed to a second name when the obtaining step is finished.

6. The image processing method of claim 5, wherein the second name is changed to a third name when the processing step is finished.

7. The image processing method of claim 5, wherein the second name comprises an extension, which represents that the processing step is in progress.

8. The image processing method of claim 6, wherein the third name comprises an extension, which represents that the processing step is finished.

9. The image processing method of claim 4, wherein when an error is occurred during the obtaining step or the processing step, the extension is changed to an extension, which represents that an error is occurred.

10. The image processing method of claim 5, wherein when the processing step is abandoned, the second name is changed to a name, which represents the abandon.

11. The image processing method of claim 1, wherein the initial name comprises an order number, which represents ordering of priority, and the obtained image file is processed by the digital image processing apparatus in order of the order number.

12. An image processing method utilizing a system including a terminal having an operating section, a server having a storing section and a digital image processing apparatus connected each other via a network, comprising the steps of:
providing a folder capable of storing a plurality of image files therein and having an initial name by the operating section of the terminal;
making an image file by scanning a photographic film or by reading a media having an image data with the digital image processing apparatus;
transferring the image file from the digital image processing apparatus into the folder; and
changing the initial name of the folder in accordance with a progressive condition of the making step and the transferring step.

13. The image processing method of claim 12, wherein the server is provided in the terminal.

14. The image processing method of claim 12, wherein the network is a local area network.

15. The image processing method of claim 12, wherein the initial name comprises an extension and the extension is changed when the initial name of the folder is changed.

16. The image processing method of claim 15, wherein the initial name of the folder is changed to a second name when the making step is finished.

17. The image processing method of claim 16, wherein the second name is changed to a third name when the transferring step is finished.

18. The image processing method of claim 12, wherein the image file is transferred from the digital image processing apparatus into the folder, when the initial name is a predetermined name.

19. The image processing method of claim 12, wherein digital image processing apparatus makes the image file by scanning the photographic film and the image file comprises at least a serial number of the personal computer, number of roll films and the order of exposures of the photographic film.

20. The image processing method of claim 12, wherein the initial name comprises an order number, which represents ordering of priority, and the obtained image file is transferred from the digital image processing apparatus into the folder in order of the order number.

21. An image processing method utilizing a system including a terminal having an operating section, a server having a storing section and a digital image processing apparatus connected each other via a network, comprising the steps of:
providing a folder capable of storing a plurality of image files therein and having an initial name by the operating section of the terminal;
making an image file by scanning a photographic film or by reading a media having an image data with the digital image processing apparatus; and
transferring the image file from the digital image processing apparatus into the folder, when the initial name of the folder is a predetermined name.

22. The image processing method of claim 21, wherein the server is provided in the personal computer.

23. The image processing method of claim 21, wherein the network is a local area network.

24. An image processing system comprising:
a server having a storing section;
a digital image processing apparatus connected with the server each other via a network;
providing section for providing a folder into the storing section, and the folder being capable of storing a plurality of image files and having an initial name;
transferring section for transferring the image file between the storing section and the digital image processing apparatus; and
changing section for changing the initial name of the folder in accordance with a progressive condition of transferring.

25. An image processing system comprising:
a server having a storing section;
providing section for providing a folder into the storing section, and the folder being capable of storing a plurality of image files and having an initial name;
transferring section for transferring the image file between the storing section and the digital image processing apparatus;
a digital image processing apparatus being capable of processing the image file to obtain a print and connected with at least the server each other via a network; and
changing section for changing the initial name of the folder in accordance with a progressive condition of processing.
